(19) United States
(12) Patent Application Publication
(10) Pub. No.: US 2014/0292298 A1
(43) Pub. Date: Oct. 2, 2014

(54) Operational Amplifier-Based Current-Sensing Circuit for DC-DC Voltage Converters and The Like

(71) Applicant: LSI Corporation, San Jose, CA (US)

(72) Inventor: Kishan Pradhan, Bangalore (IN)

(73) Assignee: LSI CORPORATION, San Jose, CA (US)

(21) Appl. No.: 13/953,241

(22) Filed: Jul. 29, 2013

(30) Foreign Application Priority Data
Apr. 1, 2013 (IN) 1489/CHE/2013

(51) Int. Cl. H02M 3/158

(52) U.S. Cl. CPC H02M 3/1588
USPC 323/286

(57) ABSTRACT

In one embodiment, an integrated circuit comprising a current-sensing circuit having a power transistor and an amplifier. The current-sensing circuit is coupled to (i) sense a current supplied to a load by a voltage source through an inductor and (ii) generate an inductor-current signal based on the sensed current. The current-sensing circuit includes: a power transistor and a sensing transistor, both coupled to receive an input voltage from the voltage source. The error amplifier has first and second input nodes and an output node. The first input node receives (i) a first voltage through the power transistor and (ii) a first current from a first biasing-current source. The second input node receives (i) a second voltage through the sensing transistor and (ii) a second current from a second biasing-current source. The inductor-current signal is generated based on at least one of the first and second voltages, and the output node has a voltage that varies with the inductor-current signal.

### CROSS-REFERENCE TO RELATED APPLICATION

This application claims priority to Indian Application No. 1489/CHE/2013 filed on Apr. 1, 2013, the disclosure of which is hereby incorporated by reference into the instant application.

### BACKGROUND

Portable electronic devices, such as cellular phones, notebook computers, and personal digital assistants (PDAs), have become increasingly popular in today's consumer market. These devices employ power-management integrated circuits (ICs), such as low-voltage switched-mode DC-DC converters, to maximize battery life and system run time. One example of such a DC-DC converter is a buck converter, which is a converter whose goal is to efficiently step down DC voltage to a lower level with minimal ripple, i.e., minimal unwanted residual periodic variation of the direct current output. In an example application, a buck converter might interface between the varying output voltage of a storage battery and a sensitive piece of electronics, such as a microprocessor. Voltage-mode and current-mode controls are both widely used in DC-DC buck converter designs. Voltage-mode buck converters may be easier to design and typically have a slower transient response. Current-mode control buck converters advantageously offer automatic over-current protection, current-mode feedback control, better stability, better line regulation, and faster dynamic response, all of which depend on the degree of accuracy of the current-sensing scheme used to sense the slowly-rising slope of the converter's inductor current.

### SUMMARY

In one embodiment, the present disclosure provides an integrated circuit comprising a current-sensing circuit having a power transistor and an amplifier. The current-sensing circuit is coupled to (i) sense a current supplied to a load by a voltage source through an inductor and (ii) generate an inductor-current signal based on the sensed current. The current-sensing circuit includes: a power transistor and a sensing transistor, both coupled to receive an input voltage from the voltage source. The error amplifier has first and second input nodes and an output node. The first input node receives (i) a first voltage through the power transistor and (ii) a first current from a first biasing-current source. The second input node receives (i) a second voltage through the sensing transistor and (ii) a second current from a second biasing-current source. The inductor-current signal is generated based on at least one of the first and second voltages, and the output node has a voltage that varies with the inductor-current signal.

Additional embodiments of the invention are described in the written description, including the claims.

### BRIEF DESCRIPTION OF THE FIGURES

In the accompanying drawings:

FIG. 1 is a schematic block diagram of an exemplary buck converter consistent with one embodiment of the disclosure;

FIG. 2 is a schematic diagram of the current-sensing circuit of FIG. 1;

FIG. 3 is a schematic diagram of the op-amp of FIG. 2; and

FIG. 4 is a timing diagram illustrating the operation of the exemplary current-sensing circuit of FIG. 2.

### WRITTEN DESCRIPTION

Buck converters produce an average output voltage lower than the input source voltage. The name “buck converter” is derived from the fact that the input voltage is “bucked,” i.e., chopped or attenuated in amplitude, such that a lower amplitude voltage appears at the output.

A buck converter typically includes a power stage and a feedback-control circuit. The power stage, which normally includes a power switch and an output filter, converts a higher input voltage to a lower output voltage. The feedback control circuit regulates the output voltage in the presence of load changes by modulating the duty cycle of the power switch.

In a basic buck converter, the power switch is implemented using an inductor and two switches (e.g., a transistor and a diode) to control the operation of the converter. The switches enable a given voltage to be chopped up to create a waveform with a new and controllable average value. The power switch further includes an L-C output filter to reduce the ripple in output to a very low level. More specifically, a typical buck converter chops an input voltage VIN into a pulse waveform at a specific duty cycle D, such that the average voltage (Voₐᵥₑ) at the output of the L-C filter is D*VIN.

In an idealized buck converter, (i) all the components are considered to be perfect, i.e., the switches have zero voltage drop when on and zero current flow when off, and the inductor has zero series resistance, and (ii) it is assumed that the input and output voltages do not change over the course of a cycle (which would imply an output capacitance that is infinitely large).

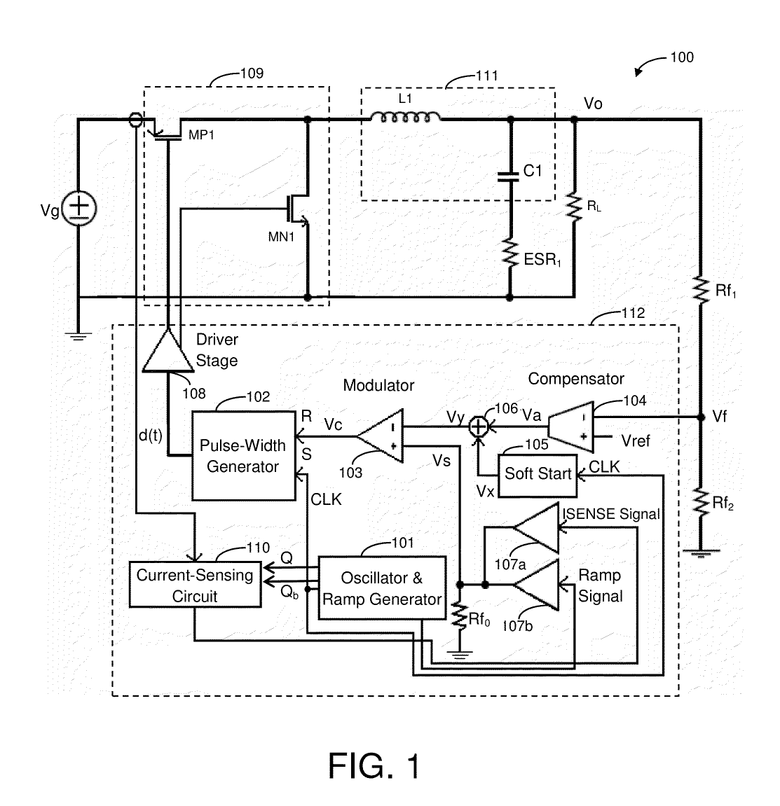

FIG. 1 shows an exemplary buck converter 100 in one embodiment of the disclosure. As shown in dashed lines, buck converter 100 can generally be divided into three portions: a power stage 109, an output filter 111, and a feedback-control circuit 112.

Input voltage source Vg is supplied (i) to current-sensing circuit 110 of feedback-control circuit 112 and (ii) to power stage 109, where a switching element formed by p-type (e.g., PMOS) transistor MP1 and n-type (e.g., NMOS) transistor MN1 chops up voltage Vg to create and provide to output filter 111 a waveform having a new and controllable average value.

Output filter 111 functions as follows. Inductor L1 reduces ripple in current passing through it, such that filtered output voltage Vo contains less ripple by means of the current through load resistor R_{L}. Load resistor R_{L} models or represents the applied load, which is the same as that through inductor L1. Filtering capacitor C1 smoothes out current changes resulting from inductor L1 so as to provide a more stable filtered output voltage Vo. If the current through inductor L1 increases, then the energy stored in inductor L1 increases. Otherwise, inductor L1 acts as a source and maintains current through load resistor R_{L}, during which period the energy stored in inductor L1 decreases and its current falls. It is noted that there is continuous conduction through the load. Output filter 111 is a low-pass circuit since, at lower frequencies, inductor L1 approximates a short, capacitor C1 is approximately open, and the input substantially passes through to the output. At higher frequencies, inductor L1 is approximately open, capacitor C1 approximates a short, and the input is substantially blocked from the output.

Resistor ESR₁ is an offsetting resistor that has a resistance selected to offset equivalent-series resistance (ESR) characteristics of capacitor C1, i.e., parasitic resistances that can cause undesirably-high internal temperatures in capacitor C1 and shorten its lifespan, in addition to resulting in lower efficiency and poorer transient response.

Resistors Rf₁ and Rf₂ form a voltage divider that is used to scale down filtered output voltage Vo by a factor of β (where β=Rf₁/(Rf₁+Rf₂)) such that the feedback voltage Vf of buck converter 100 is equal to βVo. Resistors Rf₁ and Rf₂ have resistances selected to optimize bandwidth and phase margin of buck converter 100. The feedback voltage Vf is compared with reference voltage Vref by compensator 104.

Compensator 104 receives as input both feedback voltage Vf and reference voltage Vref. Reference voltage Vref is a bandgap voltage generated and provided by a reference generator block (not shown). In alternative embodiments, reference voltage Vref may be locally generated. Compensator 104 regulates output voltage Vo of buck converter 100 at a set value despite large changes in input voltage Vg and stabilizes the overall response of the feedback-control circuit by adding compensation to counteract certain gains and phases that could jeopardize the stability of the power supply. Based on the result of comparing the fraction of the feedback voltage Vf with reference voltage Vref, compensator 104 provides an error-compensated voltage Va to summer 106.

Soft-start module 105 receives a clock signal CLK from oscillator and ramp generator 101 and produces a slowly-rising output voltage Vx, which is fed to summer 106, which applies the combined voltage signal to modulator 103. Since the output voltage Vo tends to become very high as soon as transistor MP1 is initially turned on, error-compensated voltage Va is summed with slowly-rising output voltage Vx to prevent in-rush current and output voltage overshoot during the start-up period of buck converter 100.

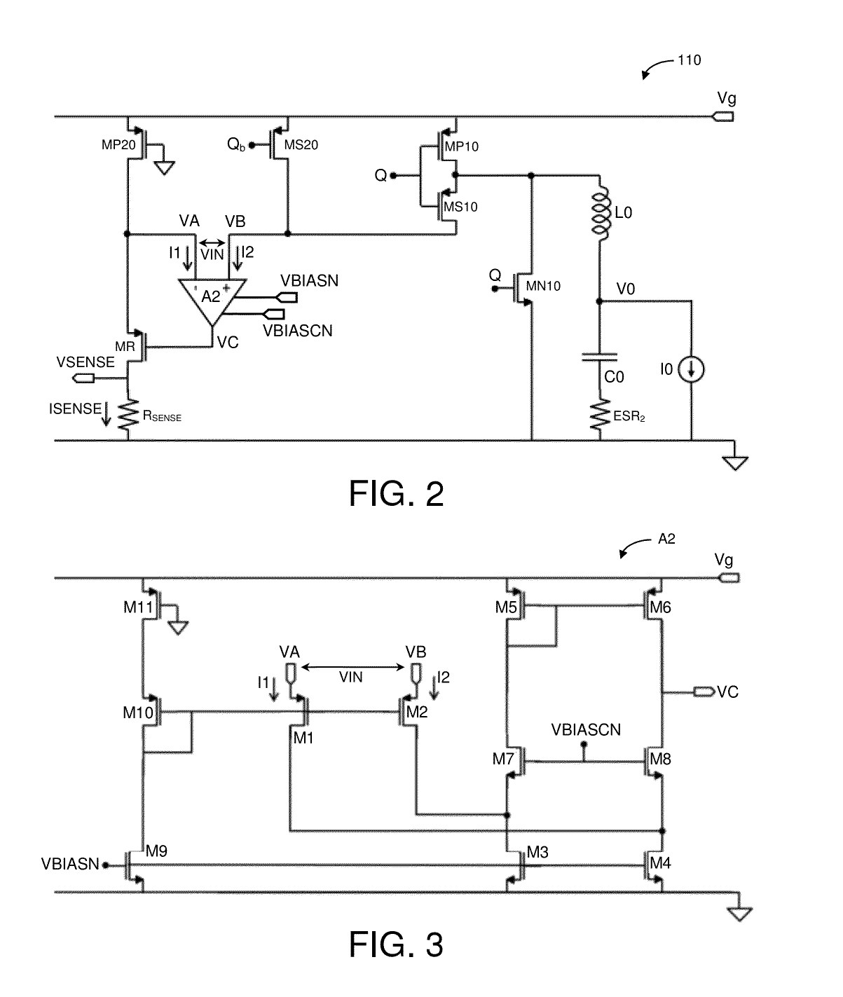

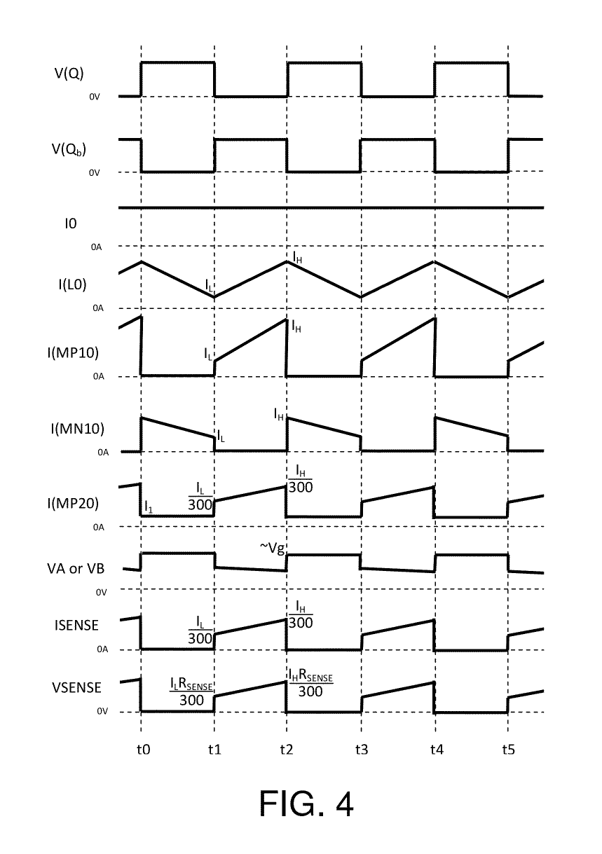

Sub-harmonic oscillation is a known issue in certain current-mode converters, such as those that have a duty cycle larger than 0.5. To eliminate sub-harmonic oscillation, (i) an inductor-current voltage signal ISENSE supplied by current-sensing circuit 110 is applied at buffer 107a, and (ii) a compensation-ramp voltage signal supplied by oscillator and ramp generator 101 is applied at buffer 107b. Buffers 107a and 107b convert the inductor-current voltage signal ISENSE and compensation-ramp voltage signal into respective current signals. The sum of the output current signals of buffers 107a and 107b is provided to resistor Rf₀, which has a value designed to scale output voltage Vo to the reference-voltage value of Vref. A sense voltage Vs is generated as the summed current from buffers 107a, 107b is pumped to Rf₀. Sense voltage Vs is compared with control voltage Vy provided at the output of summer 106. Compensated voltage Va, which is provided to summer 106, is generated by comparing Vref with feedback voltage Vf. The value of Rf₀ is desirably selected such that Rf₀×I_{H}=Vy, where I_{H} is the maximum current flowing through inductor L0 of FIG. 2, as discussed in further detail below with respect to the timing diagram of FIG. 4. Resistor Rf₀ converts the combined current signal from buffers 107a and 107b into sense voltage signal Vs, which is applied to modulator 103.

Clock signal CLK is also supplied by oscillator and ramp generator 101 to pulse-width generator 102 for use in pulse-width modulation control. Oscillator and ramp generator 101 also generates clock signals Q and Q_{b}, which are provided to control the timing of current-sensing circuit 110.

Modulator 103, which may have the same structure as compensator 104, compares the combined voltage signal Vy from summer 106 with the voltage signal resulting from buffers 107a, 107b and resistor Rf₀ to generate and apply error-compensated control voltage Vc to pulse-width generator 102. Modulator 103 provides stability to the overall response of feedback-control circuit 112.

Pulse-width generator 102 includes (not shown) a comparator and a set-reset (SR) latch. Pulse-width generator 102 receives control-voltage signal Vc from modulator 103 and clock signal CLK from oscillator and ramp generator 101 and generates and provides to driver stage 108 a duty cycle d(t), which is defined by the output Va of compensator 104, the compensation-ramp signal, and inductor-current signal ISENSE. Driver stage 108 is coupled to the gates of transistors MP1 and MN1 and controls the operation of power stage 109 based on duty cycle d(t). This is achieved by controlling the on-time and off-time durations of transistors MP1 and MN1 so as to provide negative feedback that controls perturbation of the duty cycle, thereby regulating output voltage Vo of buck converter 100.

FIG. 2 shows an exemplary implementation of current-sensing circuit 110 of FIG. 1. Current-sensing circuit 110 provides current-mode DC-DC converter feedback control to buck converter 100. Current-sensing circuit 110 is coupled to sense the current at the source of transistor MP1 and output inductor-current signal ISENSE. To provide a high degree of accuracy and speed, as well as to significantly reduce systematic offset, current-sensing circuit 110 employs an operational amplifier (op-amp) A2.

Op-amp A2 is coupled to stable DC-bias voltages VBIASN and VBIASCN, which are used by op-amp A2 for generating current. DC-bias voltages VBIASN and VBIASCN may be generated using any suitable circuitry known in the art for generating stable DC bias voltages.

Op-amp A2 has input nodes VA, VB respectively coupled to receive the drain-to-source voltages VDS of sensing transistor MP20 and power transistor MP10. Transistor MS10 functions as a switch. When clock signal Q is high, transistor MS10 connects node VB to the drain of transistor MS20 and turns off transistor MP10. The VDS of transistor MS10 is negligible, since it conducts relatively little current. Op-amp A2 has an output node VC, where inductor-current signal ISENSE varies with and is determined by the voltage at node VC. Op-amp A2 serves as a voltage mirror by maintaining a condition at which the voltage at nodes VA and VB have the same voltage level. Op-amp A2 accomplishes this by forcing the drain-to-source voltages VDS of power transistor MP10 and sensing transistor MP20 to be equal, thereby accounting for possible input offset due to input-pair mismatch (it is noted that the VDS of transistor MS10 is negligible and/or can be compensated with circuitry known in the art). Two biasing-current sources I1 and I2, which have relatively small and equal magnitudes pulling current from transistors MP20 and MP10, respectively, are provided at respective nodes VA and VB, such that I1,I2<<I(MP10,MP20). Biasing current I2 flows through transistor MS20 when transistor MP10 is off. Biasing currents I1 and I2 are eventually generated by means of DC-bias voltages VBIASN and VBIASCN. Although biasing currents I1 and I2 desirably have equal magnitudes, the currents might not be equal in some embodiments of the disclosure.

An output load current I0, which flows through power transistor MP10, is mirrored to sensing transistor MP20 and is sourced by transistors MP10 and MN10 and capacitor C0. The current flowing through transistor MP10 is a fraction of output load current I0. Any change in VB will force a similar change in VA due to the virtual short circuit provided by op-amp A2. The size ratio of transistor MP10 to transistor MP20 is 300:1, and the ratio of current flowing through transistor MP10 relative to the current flowing through transistor MP20 is also 300:1. Accordingly, the size W/L of transistor MP20, where W represents width and L represents length, is 300 times less than that of transistor MP10, and the current of transistor MP20 is 300 times less than that of transistor MP10. Since drain-to-source voltage VDS ∝ I/(W/L), the drain-to-source voltages and drain-current densities of transistors MP10 and MP20 are nearly the same. Nevertheless, transistors MP10 and MP20 are scaled so that transistor MP10, which is on the output side of circuit 110, has an aspect ratio that is much greater than that of transistor MP20, which on the sensing side. For example, in one embodiment, transistor MP10 has an aspect ratio of 300:1, while transistor MP20 has an aspect ratio of 1:1. As a result, the sensing current ISENSE is proportional to, and much smaller than, the output current I0 flowing through the load. It should be understood that the selection and matching of transistors MP10 and MP20 depends on process parameters, such as mobility, oxide capacitance, and threshold voltage. Resistor R_{SENSE} is used to convert the sensing current signal ISENSE to a voltage signal VSENSE that is proportional to the sensing current ISENSE.

Transistor MS20 provides a voltage close to the voltage at node VB when clock signal Q is high; otherwise, it would take too long to reach the voltage at node VB again when clock signal Q is low. Transistor MN10 is a power transistor that provides current when clock signal Q is high (and transistor MP10 is off). Inductor L0, in conjunction with capacitor C0, serve to filter out AC ripple waveforms and allow pure DC components to pass through.

Resistor ESR₂ is an offsetting resistor that has a resistance selected to offset equivalent-series resistance (ESR) characteristics of capacitor C0.

FIG. 3 shows an exemplary implementation of op-amp A2 of FIG. 2. Since op-amp A2 is used to ensure that VA and VB remain the same, a high-gain amplifier is used for current sensing. As shown, op-amp A2 includes six p-type (e.g., PMOS) transistors M1, M2, M5, M6, M10, and M11, and five n-type (e.g., NMOS) transistors M3, M4, M7, M8, and M9, with transistors M1-M11 being desirably matched. The gates of transistors M3, M4, and M9 are coupled to DC bias voltage VBIASN, and the gates of transistors M7 and M8 are coupled to DC-bias voltage VBIASCN.

The output branch of op-amp A2 includes a mirrored transistor pair M5, M6, which employs a PMOS input pair M1, M2 to support high-input, common-mode voltage Vg, as shown in FIG. 3. This input pair M1, M2 also provides the biasing currents I1 and I2. This topology keeps the output voltage VC of op-amp A2 close to Vg-VGS(MR) (where VGS(MR) represents the gate-to-source voltage of transistor MR) when input voltage VIN is zero, which results in values of VA=VB. The values of VA and VB are equal because there is no systematic offset. Such systematic offset might otherwise result if the input voltage VIN of op-amp A2 is zero, and the output voltage level VC of op-amp A2 is close to the VGS of transistor M4, with the desired level being Vg-VGS(MR). Since MP10 and MP20 of FIG. 2 have different VDS values, the currents flowing through these components are not exactly scaled and would result in inaccuracy in current sensing without the use of input pair M1, M2.

Op-amp A2 functions as follows. Input voltage VIN is equal to the difference between VA and VB. Generally, input voltage VIN is provided at the gates of input pair transistors M1, M2, which have sources at virtual ground. Although the gates receive a constant voltage, the input voltages provided to the sources will vary. The change in the ground-to-source voltages VGS of transistors M1, M2 results in a change in the output of op-amp A2.

FIG. 4 is an exemplary timing diagram for the operation of current-sensing circuit 110 of FIG. 2.

As shown, each of clock signals Q and Qb has a square waveform with a 50% duty cycle. The voltage of clock signal Q transitions high at time t0, low at time t1, and so forth. Clock signal Qb has a timing inverse to that of clock signal Q and a voltage that transitions low at time t0, high at time t1, and so forth.

Since the gate of transistor MP20 is tied to ground, transistor MP20 is always on.

At time t0, clock signal Q transitions high, causing current to flow through transistor MN10, and clock signal Q_{b} transitions low, causing current to flow through transistor MS20. MP10, MS10, and MS20 are p-type transistors that turn on when their gate voltage is low and off when their gate voltage is high. MN10 is an n-type transistor that turns on when its gate voltage is high and off when its gate voltage is low. Note that, as shown in FIG. 4, between t0 and t1, Q is high and Q_{b} is low, such that I(MP10) is zero (i.e., MP10 is off) and I(MN10) is not zero (i.e., MN10 is on). Consequently, a current of I_{H} flows through transistor MN10 and inductor L0, a current of I₁ flows through transistor MP20, and a current of 0 A flows through transistor MP10. The values of VA and VB, which are approximately equal to one another, approximate the value of VDS(MP20/MS20). Sensed current ISENSE has a value of I_{H}/300, and voltage signal VSENSE has a value of I_{H}R_{SENSE}/300. Output current I0 remains at a constant value.

Between time t0 and time t1, the current flowing through transistor MN10 and inductor L0 gradually falls to a value of I_{L}. A current of I₁ continues to flow through transistor MP20, and a current of 0 A continues to flow through transistor MP10. The values of VA and VB both continue to approximate the value of Vg. Sensed current ISENSE continues to have a value of I_{H}/300, and voltage signal VSENSE continues to have a value of I_{H}R_{SENSE}/300. Output current I0 continues to remain at a constant value.

At time t1, clock signal Q becomes low, causing current to flow through transistor MP10, and clock signal Q_{b} becomes high, causing current not to flow through transistor MN10. Consequently, a current of I_{L} flows through transistor MP10 and inductor L0, a current of I_{L}/300 flows through transistor MP20, and a current of 0 A flows through transistor MN10. The values of VA and VB both decrease to a value greater than 0 A and no longer approximates the value of Vg. Sensed current ISENSE has a value of I_{L}/300, and voltage signal VSENSE has a value of I_{L}R_{SENSE}/300. Output current I0 continues to remain at a constant value.

Between time t1 and time t2, the current flowing through transistor MP10 and the inductance of inductor L0 gradually increase to a value of I_{H}. The current flowing through transistor MP20 gradually increases to a value of I_{H}/300, and a current of OA continues to flow through transistor MN10. The values of VA and VB both gradually fall as the currents through MP10 and MP20 gradually rise. Sensed current ISENSE gradually increases to a value of I_{H}/300, and voltage signal VSENSE gradually increases to a value of I_{I}R_{SENSE}/300. Output current I0 continues to remain at a constant value.

At time t2, the foregoing process repeats, just as at time t0.

The following relationships therefore exist, where W and L represent transistor width and length, respectively:

$$\frac{I ( MP 10 )}{I ( MP 20 )} = \frac{300}{1} = \frac{W ( MP 10 ) / L ( MP 10 )}{W ( MP 20 ) / L ( MP 20 )} ;$$

$$( {I}_{L} / 300 ) ≫ {I}_{1} , {I}_{2} ;$$

$${I}_{1} = {I}_{2} ; and \\ ( {I}_{L} / 300 - {I}_{1} ) \approx {I}_{L} / 300.$$

### Therefore, VSENSE ∝ I(MP1), and

$$VSENSE = \frac{RSENSE}{300} \times I ( MP 1 ) .$$

Accordingly, current-sensing circuit 110 accurately senses the current flowing through PMOS power transistor MP1.

It is noted that op-amp A2 of current-sensing circuit 110 employs a common-gate arrangement for the input stage, which includes transistors M1 and M2. This common-gate arrangement tends to cause lower systematic offset and has reduced variations in accuracy relative to other op-amps, such as those that employ a common-source input-stage arrangement. This is because, when the input voltage is zero, the common-gate arrangement results in a default output voltage value that is close to the desired output voltage value. A small change in input will provide the actual desired output voltage level. Thus, the value of VA is very close to the value of VB, and negligible systematic offset exists. In a common-source configuration, there would be a relatively large difference between the default output voltage value and the desired output voltage value. In that scenario, to bring the output voltage value close to the desired level, the input (VA−VB) must be increased, thereby resulting in systematic offset (i.e., VA=VB+systematic offset).

Impedances within an op-amp create phase delays, and, at a high enough frequency, the closed-loop phase delay exceeds 180°. If the closed-loop gain of the op-amp at that frequency is at least unity, then the desirable negative feedback of the amplifier converts into positive feedback, and the amplifier oscillates. To maintain the phase shift of the op-amp below 180° for all frequencies at which the loop gain exceeds unity, sufficient capacitance is employed in the circuit so as to create the dominant pole of the op-amp, shifting the pole downward in frequency and thus maintaining the gain of the op-amp below unity when its phase shift equals 180°. This arrangement, as employed in current-sensing circuit 110, is known as dominant-pole compensation. A voltage converter consistent with certain embodiments of the disclosure is able to provide high-speed switching due to the use of a single dominant-pole compensation arrangement.

A current-sensing circuit consistent with embodiments of the disclosure may have utility in circuits other than buck converters, including other DC-DC voltage converters, regulator circuits, and the like.

Although a current-sensing circuit in certain embodiments of the disclosure is described herein as employing an operational amplifier, it should be recognized that other types of error amplifiers and amplification schemes could alternatively be used.

Embodiments of the disclosure may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro controller, general-purpose computer, or other processor.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Signals and corresponding nodes or ports may be referred to by the same name and are interchangeable for purposes herein.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the disclosure. Embodiments of the disclosure can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the disclosure. When implemented on a general-purpose processor, the program code segments combine with the processor to provide a unique device that operates analogously to specific logic circuits.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo-code, and the like represent various processes that may be substantially represented in a computer-readable medium and be executed by a computer or processor, whether or not such computer or processor is explicitly shown.

Unless explicitly stated otherwise, each numerical value and range should be interpreted as being approximate as if the word “about” or “approximately” preceded the value of the value or range.

It will be further understood that various changes in the details, materials, and arrangements of the parts (e.g., if appropriate, circuits, sub-circuits, and components) which have been described and illustrated in order to explain embodiments of the disclosure may be made by those skilled in the art without departing from the scope of the disclosure as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

I claim:

1. An integrated circuit comprising:
a current-sensing circuit coupled to (i) sense a current supplied to a load by a voltage source through an inductor and (ii) generate an inductor-current signal based on the sensed current, the current-sensing circuit comprising:
a power transistor (e.g., MP10) and a sensing transistor (e.g., MP20), the power transistor and the sensing transistor coupled to receive an input voltage from the voltage source; and
an error amplifier (e.g., A2) having first and second input nodes and an output node,
wherein:
the first input node is coupled to receive (i) a first voltage through the power transistor and (ii) a first current from a first biasing-current source;
the second input node is coupled to receive (i) a second voltage through the sensing transistor and (ii) a second current from a second biasing-current source;
the inductor-current signal is generated based on at least one of the first and second voltages; and
the output node has a voltage that varies with the inductor-current signal.

2. The integrated circuit of claim 1, wherein the error amplifier serves as a voltage mirror for the first and second voltages.

3. The integrated circuit of claim 1, wherein the first and second biasing-current sources have equal currents.

4. The integrated circuit of claim 1, wherein the error amplifier is an operational amplifier comprising an input pair of transistors.

5. The integrated circuit of claim 4, wherein the transistors of the input pair have common gates.

6. The integrated circuit of claim 4, wherein the transistors of the input pair have sources respectively coupled to the first and second input nodes.

7. The integrated circuit of claim 4, wherein transistors of the input pair have sources that are not directly coupled.

8. The integrated circuit of claim 1, wherein the first and second biasing-current sources (i) pull current from the power transistor and the sensing transistor, respectively, and (ii) pull no current from the first and second input nodes of the error amplifier.

9. The integrated circuit of claim 1, wherein the sensing transistor has a current flowing therethrough that is proportional to the current flowing through the power transistor.

10. The integrated circuit of claim 1, wherein the sensing transistor has an aspect ratio approximately 300 times greater than the aspect ratio of the power transistor.

11. A method for generating an inductor-current signal based on a sensed current supplied to a load by a voltage source through an inductor, the method comprising:
receiving, at a power transistor and a sensing transistor, an input voltage from the voltage source;
providing, to the first input node of an error amplifier having first and second input nodes and an output node, (i) a first voltage through the power transistor and (ii) a first current from a first biasing-current source;
providing, to the second input node, (i) a second voltage through the sensing transistor and (ii) a second current from a second biasing-current source; and
generating the inductor-current signal based on at least one of the first and second voltages, wherein the output node has a voltage that varies with the inductor-current signal.

12. The method of claim 11, wherein the error amplifier serves as a voltage mirror for the first and second voltages.

13. The method of claim 11, wherein the first and second current sources have equal currents.

14. The method of claim 11, wherein the error amplifier is an operational amplifier comprising an input pair of transistors.

15. The method of claim 14, wherein the transistors of the input pair have common gates.

16. The method of claim 14, wherein the transistors of the input pair have sources respectively coupled to the first and second input nodes.

17. The method of claim 14, wherein transistors of the input pair have sources that are not directly coupled.

18. The method of claim 11, wherein the first and second biasing-current sources (i) pull current from the power transistor and the sensing transistor, respectively, and (ii) pull no current from the first and second input nodes of the error amplifier.

19. The method of claim 11, wherein the sensing transistor has a current flowing therethrough that is proportional to the current flowing through the power transistor.

20. The method of claim 11, wherein the sensing transistor has an aspect ratio approximately 300 times greater than the aspect ratio of the power transistor.
